(19) United States
(12) Patent Application Publication
(10) Pub. No.: US 2026/0056420 A1
(43) Pub. Date: Feb. 26, 2026

(54) DISPLAY GRATING, 3D DISPLAY DEVICE, AND 3D DISPLAY METHOD

(71) Applicant: GUANGDONG FUTURE TECHNOLOGY CO., LTD., Shenzhen (CN)

(72) Inventors: Shu He, Shenzhen (CN); Wei Gao, Shenzhen (CN)

(21) Appl. No.: 19/103,265

(22) PCT Filed: Nov. 16, 2022
(86) PCT No.: PCT/CN2022/132116

§ 371 Date: Feb. 12, 2025

(30) Foreign Application Priority Data
Nov. 17, 2021 (CN) 202111360048.X

(51) Int. Cl. G02B 30/32; G02B 30/33; G02F 1/1335

(52) U.S. Cl. CPC G02B 30/32; G02B 30/33; G02F 1/133504; G02F 1/133553; G02F 1/133562

(57) ABSTRACT

Described herein are a display grating, a 3D display device, and a 3D display method, which can achieve free switching between a 2D display effect and a 3D display effect. The display grating comprises a grating substance. A first outer surface of the grating substance is provided with multiple reflective structures arranged in sequence; a first inner surface of the grating substance is provided with multiple scattering structures arranged in sequence; the scattering structures comprise multiple light-exiting points; and a first side surface of the grating substance is provided with multiple light sources arranged in sequence.

### CROSS-REFERENCE TO RELATED APPLICATION

The present application is the national stage of International Application No. PCT/CN2022/132116, filed on Nov. 16, 2022, which claims priority to Chinese Patent Application No. 202111360048.X, filed on Nov. 17, 2021. The disclosures of the aforementioned applications are incorporated in the present application by reference in their entirety.

### TECHNICAL FIELD

The present application relates to the field of naked-eye 3D, and in particular to a display grating, a 3D display device and a 3D display method.

### BACKGROUND

The slit grating is an optical element based on the principle of light blocking. By adjusting the distance between the backlight source and the slits, the light beams visible to the left eye is invisible to the right eye, and the light beams visible to the right eye is invisible to the left eye. The pixel groups of the display panel, through the light beams coming into the left and right eyes respectively, form a complete image vision in each of the left and right eyes, and thus the observer can have a stereoscopic vision.

The slit grating is an optical element with a series of equidistant parallel grooves. The slit grating is made of reflective material and can reflect light beams back to the backlight panel. After multiple reflections in the backlight panel, the light beams are emitted from the light-transmitting area, which effectively increases the brightness of the 3D display.

At present, one of the main technologies of naked-eye 3D is realized through the slit grating. However, the traditional slit grating can only realize 3D display and cannot switch between 2D display and 3D display. Even if 2D display is realized, the 2D effect is not satisfactory.

### SUMMARY

A first aspect of the embodiments of the present application provides a display grating. The display grating includes:
a grating substrate;
a first outer surface of the grating substrate is provided with a plurality of sequentially arranged reflective structures;
a first inner surface of the grating substrate is provided with a plurality of sequentially arranged scattering structures which include a plurality of light-exiting points;
a first side surface of the grating substrate is provided with a plurality of sequentially arranged light sources.

A second aspect of the present application provides a 3D display device. The 3D display device includes:
a backlight panel;
a liquid crystal display panel;
a display grating located between the backlight panel and the liquid crystal display panels, a first outer surface of the display grating being provided with a plurality of sequentially arranged reflective structures, a first inner surface of the display grating being provided with a plurality of sequentially arranged scattering structures, the scattering structures including a plurality of light-exiting point, and a first side surface of the display grating being provided with a plurality of sequentially arranged light sources; and
a controller connected with the light sources through a control line, and configured to control the light sources to turn off or turn on, the controller controlling the light sources to turn on through the control line when the display grating is in a 2D working state, and controlling the light sources to turn off through the control line when the display grating is in a 3D working state.

A third aspect of the present application provides a 3D display method, including:
when to perform 3D display, determining, by the 3D display device, positions of eyes of a target user who watches a 3D image displayed by the 3D display device at a preset distance, wherein the 3D display device comprises a display grating located between a backlight panel and a liquid crystal display panel of the 3D display device, a first outer surface of the display grating is provided with a plurality of sequentially arranged reflective structures, a first inner surface of the display grating is provided with a plurality of sequentially arranged scattering structures which comprise a plurality of light-exiting points, and a first side surface of the display grating is provided with a plurality of sequentially arranged light sources, and the controller is connected with the light sources through a control line and configured to control the light sources to turn off or turn on, the controller controls the light sources to turn on through the control line when the display grating is in a 2D working state, and controls the light sources to turn off through the control line when the display grating is in a 3D working state;
determining, according to the positions, a left light beam group from the backlight panel to a left eye of the target user and a right light beam group from the backlight panel to a right eye of the target user, the backlight panel corresponding to the 3D display, and light beams of the left light beam group and the right light beam group corresponding to pixels of the liquid crystal display panel;
dividing the pixels of the liquid crystal display panel into a left-view pixel group and a right-view pixel group according to the left light beam group and the right light beam group;
displaying a left image and a right image on the liquid crystal display panel based on the left-view pixel group and the right-view pixel group correspondingly, wherein the left image and the right image correspond to the 3D image.

In a possible embodiment, the displaying the left image and the right image on the liquid crystal display panel based on the left-view pixel set and the right-view pixel set correspondingly includes:
determining a first position group of the left-view pixel group on the liquid crystal display panel and a second position group of the right-view pixel group on the liquid crystal display panel;
displaying pixels of the left image at positions of the first position group; and
displaying pixels of the right image at positions of the second position group.

In a possible embodiment, the determining, according to the positions, the left light beam group from the backlight panel to the left eye of the target user and the right light beam group from the backlight panel to the right eye of the target user includes:
determining an initial left light beam group from the backlight panel to the left eye of the target user and an initial right light beam group from the backlight panel to the right eye of the target user according to the positions;
comparing the initial left light beam group with the initial right light beam group to obtain a resulted light beam group;
determining light beams in the initial left light beam group but out of the resulted light beam group to form the left light beam group;
determining light beams in the initial right light beam group but out of the resulted light beam group to form the right light beam group.

Compared with the related art, the embodiments provided by the present application sets scattering structures and reflective structures on the display grating, and sets light sources on a side surface of the grating substrate, the light sources are turned on when 2D display is performed to make up for the loss of brightness caused by the reflective structures reflecting the light from the backlight panel, and the light sources are turned off when the 3D display is performed, so that the display grating can cooperate with the liquid crystal display panel for 3D display, and switching between 2D display and 3D display is realized.

### BRIEF DESCRIPTION OF FIGURES

FIG. 1 is a schematic diagram of the light splitting characteristics of a slit grating according to an embodiment of the present application.

FIG. 2 is a schematic structural diagram of a display grating according to an embodiment of the present application.

FIG. 3 is a schematic diagram of a first outer surface of the display grating according to an embodiment of the present application.

FIG. 4 is a schematic diagram of a first inner surface of the display grating according to an embodiment of the present application.

FIG. 5 is a schematic flowchart of a method for preparing a display grating according to an embodiment of the present application.

FIG. 6 is a schematic structural diagram of a 3D display device according to an embodiment of the present application.

FIG. 7 is a schematic diagram of a three-dimensional structure of the 3D display device according to an embodiment of the present application.

FIG. 8 is a schematic flowchart of a 3D display method according to an embodiment of the present application.

FIG. 9 and FIG. 10 show detailed operations of the 3D display method of FIG. 8 according to an embodiment of the present application.

### DETAILED DESCRIPTION

The embodiments of the present application will be clearly and completely described below with reference to the drawings in the embodiments of the present application. Obviously, the described embodiments are only some, not all of the embodiments of the present application.

In order to enable those skilled in the art to better understand the solutions of the present application, the technical solutions in the embodiments of the present application will be clearly and completely described below in conjunction with the drawings in the embodiment of the application. Obviously, the described embodiments are only some, and not all of the embodiments of the present application. Based on the embodiments in the present application, all other embodiments obtained by those skilled in the art without making creative efforts fall in the claimed scope of the present application.

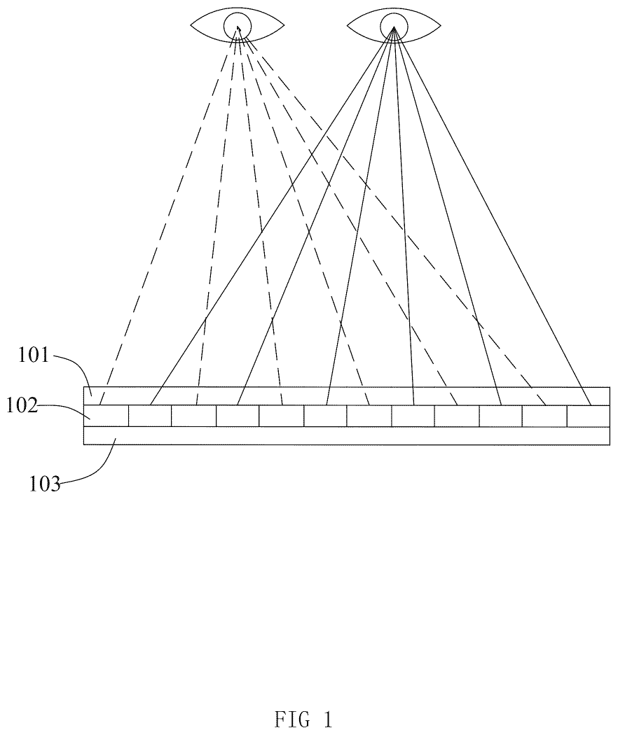

Referring to FIG. 1, FIG. 1 is a schematic diagram showing light splitting characteristics of a slit grating according to an embodiment of the present application, which includes:
a display panel 101, a slit grating 102 and a backlight source 103;

Due to the light splitting characteristics of the slit grating 102, light beams visible to a user's left eye is invisible to his right eye, while light beams visible to his right eye is invisible to his left eye by adjusting a distance between the slit grating 102 and the backlight source 103. The light beams coming into each of the right eye and the left eye form vision of a complete image through a pixel groups of the display panel 101, thus the user can have a stereoscopic vision.

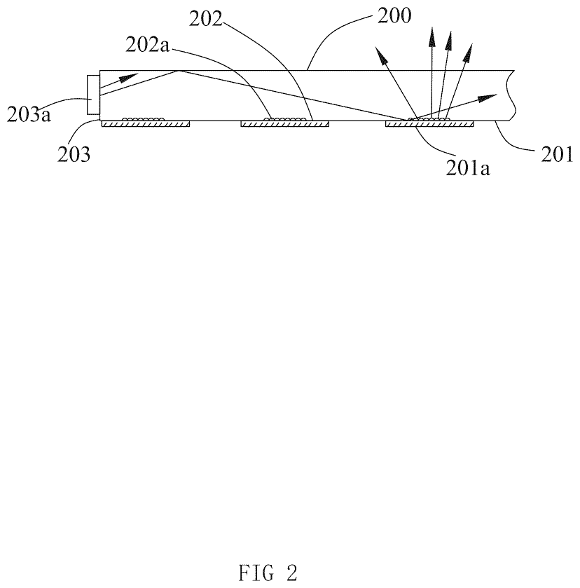

Referring to FIG. 2, FIG. 2 is a schematic structural diagram of a display grating according to an embodiment of the present application. The display grating includes:
a grating substrate 200. The grating substrate 200 can be made of glass, or another material, such as acrylic, and the material of the grating substrate 200 is not to be limited as long as it can transmit light.

A first outer surface 201 of the grating substrate 200 is provided with a plurality of reflective structures 201a arranged in sequence, a first inner surface 202 of the grating substrate 200 is provided with a plurality of scattering structures 202a arranged in sequence, and the scattering structures includes a plurality of light-exiting points. It can be understood that the first outer surface 201 is the appearance of the grating substrate 200, the first inner surface 202 is disposed inside the grating substrate 200, and a distance between the first inner surface 202 and the first outer surface 201 is a depth of the scattering structures 202a.

A first side surface 203 of the grating substrate 200 is provided with a plurality of light sources 203a arranged in sequence. The light sources 203a can be LED lamp beads, or other light sources, which are not specifically limited, as long as the light sources 203a can provide a controllable light source for the grating substrate 200.

The grating substrate 200 is also provided with a control line (not shown in the figure), and the control line is connected to the light sources 203a, that is, when the display grating is in a 2D working state, the light sources 203a are controlled to be turned on through the control line, and when the display grating is in a 3D working state, the light sources 203 are controlled to be turned off through the control line. Since the grating substrate 200 is located between a backlight panel and a display panel, and some of the light beams from the backlight panel are reflected by the reflective structures 201a provided on the grating substrate 200 during 2D display, the light sources 203a provided on the display grating 200 can be controlled to light up through the control line when the display grating 200 is in the 2D working state, so as to make up for the light beams reflected by the reflective structures 201a.

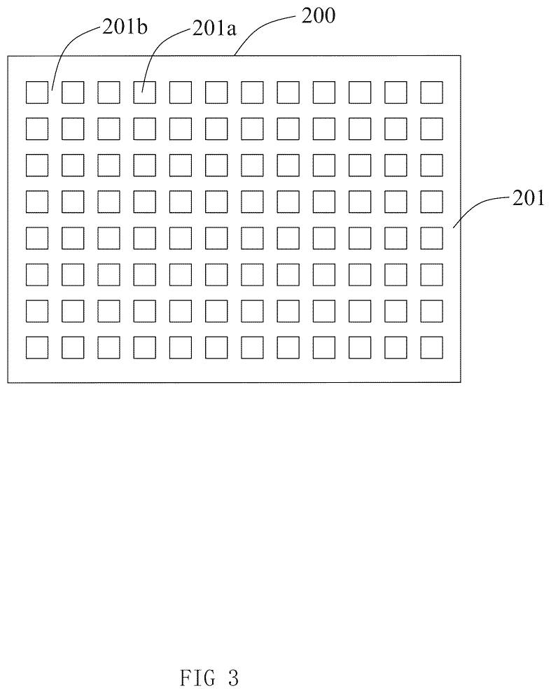

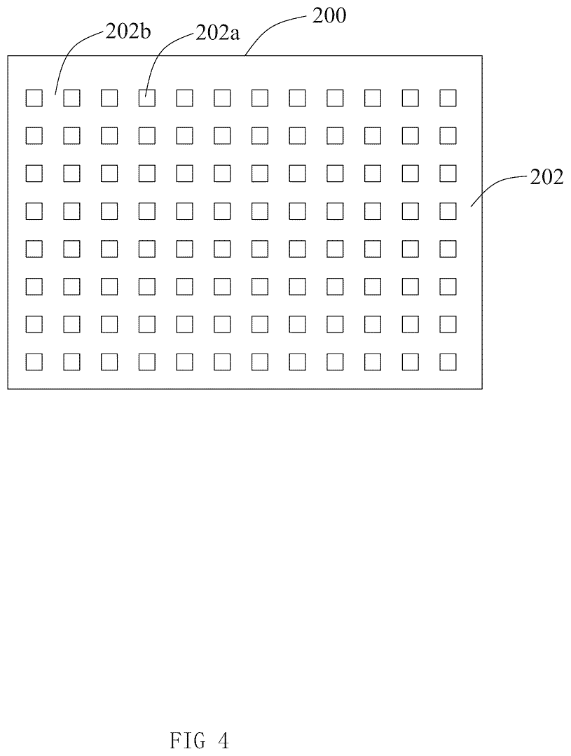

The first outer surface 201 and the first inner surface 202 will be described in detail below in conjunction with FIG. 3 and FIG. 4. Referring to FIG. 3, FIG. 3 is a schematic diagram of the first outer surface 201 of the display grating according to an embodiment of the present application. The first outer surface 201 includes a first transparent area 201b, and the first transparent area 201b is an area of the first outer surface 201 other than areas where the reflective structures 201a are located. As shown in FIG. 3, each reflective structure 201a may occupy a square area, and the first transparent area 201b surrounds the square areas. Of course, each reflective structure 201a may occupy a rectangular area or a circular area, which is not specifically limited.

Referring to FIG. 4, FIG. 4 is a schematic diagram of the first inner surface 202 of the display grating according to an embodiment of the present application. The first inner surface 202 includes a second transparent area 202b, and the second transparent area 202b is an area of the first inner surface 202 except areas where the scattering structures 202a are located. As shown in FIG. 4, each scattering structure 202a may occupy a square area, and the second transparent area 202b surrounds the square areas. Of course, each scattering structure 202a may occupy a rectangular area or a circular area, which is not specifically limited.

It should be noted that the scattering structures 202a correspond to the reflective structures 201a, that is, the number of the reflective structures 201a on the first outer surface 201 is equal to the number of the scattering structures 202a on the first inner surface 202. An occupied area of each scattering structure 202a is smaller than or equal to an occupied area of each reflective structure 201a, a center line of each scattering structure 202a coincides with a center line of a corresponding reflective structure 201a, and the reflective structures 201a are extended away from the first outer surface 201 for a preset distance, that is, the reflective structures 201a are higher than the grating substrate 200.

It should also be noted that the scattering structures 202a are sequentially arranged recesses which are formed by etching the first outer surface 201. The recesses have a depth equal to the preset distance. Bottoms of the recesses are provided with a plurality of light-exiting points. The plurality of light-exiting points are configured to scatter the light beams from the light source 203 to make up for the light beams reflected by the reflective structures 201a.

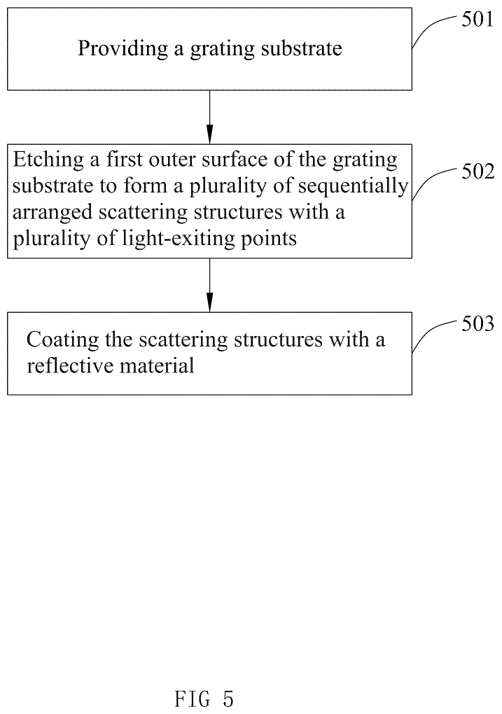

A method for preparing the display grating according to the present application will be described below in conjunction with FIG. 5. Referring to FIG. 5, FIG. 5 is a schematic flowchart of the method for preparing the display grating according to an embodiment of the present application, which includes:
501, providing a grating substrate.

In this embodiment, when to prepare the display grating, the material for the grating substrate can be firstly determined. The material of the grating substrate can be glass or another material, such as acrylic, and the material of the grating substrate 200 is not to be limited as long as it can transmit light. Then, the size of the grating substrate is determined according to the needs. For example, if a 5-inch grating substrate of glass needs to be prepared, a piece of glass of five inches can be selected as the grating substrate.
502, etching a first outer surface of the grating substrate to form a plurality of sequentially arranged scattering structures with a plurality of light-exiting points.

In this embodiment, after the grating substrate is selected, a plurality of sequentially arranged scattering structures may be formed by etching the first outer surface of the grating substrate. The scattering structures are recesses with a preset depth, and a plurality of light-exiting points are arranged in the recesses. As shown in FIG. 2, the first outer surface 201 is the appearance of the grating substrate 200, and the plurality of sequentially arranged scattering structures 202a are formed on the first outer surface 201 by etching, that is, the plurality of fine recesses arranged in sequence are formed by etching the first outer surface 201, the recesses have a preset depth, and a plurality of light-exiting points are arranged at bottoms of the recesses and scatters the light beams emitted by the light source 203a corresponding to the grating substrate 200 to make up for the light shielding effect caused by the grating. The etched first inner surface 202 is shown in FIG. 4, and the first inner surface 202 after etching includes the scattering structures 202a and a transparent area 202b.
503, coating the scattering structures with a reflective material.

In this embodiment, after the first outer surface of the grating substrate is etched to form the plurality of sequentially arranged scattering structures, the reflective material can be plated on the scattering structures. Each scattering structure covered with the reflective material is higher than the first outer surface and have a surface area greater than or equal to a surface area of the scattering structure without the reflective material. In an embodiment, a printing mold corresponding to the grating substrate may be provided to print a first protective layer and a second protective layer on the first outer surface, and the first protective layer is located between the second protective layer and the first outer surface. The first outer surface covered with the protective layer is etched by corrosive liquid (or the first outer surface is etched by another means, such as laser, which is not limited), to obtain the plurality of scattering structures arranged in sequence. The grating substrate after etching is cleaned, and then the second protective layer are removed. The corresponding reflective material is plated on the scattering structures after the second protective layer is removed, and the first outer surface covered with the reflective material is shown in FIG. 3. The grating substrate is cleaned again, and the first protective layer is removed to obtain a display grating.

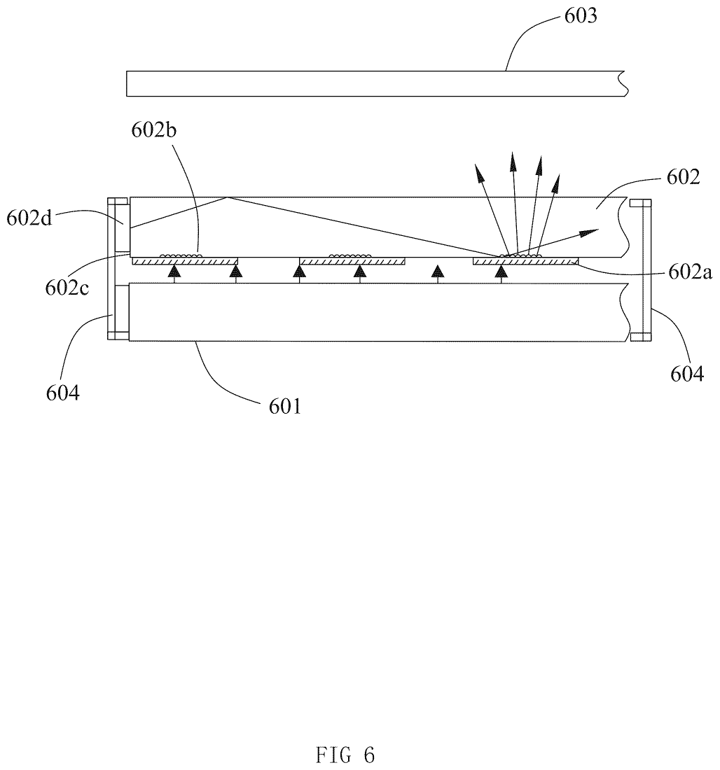

The 3D display device provided by the embodiments of the present application will be described below in conjunction with FIG. 6. Referring to FIG. 6, FIG. 6 is a schematic structural diagram of the 3D display device provided by an embodiment of the present application, which includes:
a backlight panel 601, a display grating 602, a liquid crystal display panel 603 and a controller (not shown in the figure).

The display grating 602 is disposed between the backlight panel 601 and the liquid crystal display panel 603. A first outer surface of the display grating 602 is provided with a plurality of reflective structures 602a arranged in sequence, a first inner surface of the display grating 602 is provided with a plurality of scattering structures 602b arranged in sequence, and the scattering structures 602b include a plurality of light-exiting points.

A first side surface 602c of the display grating 602 is provided with a plurality of sequentially arranged light sources 602d. The controller is connected with the light sources 602d through a control line, and is configured to control the light sources 602d to be turned off or on. That is, when the display grating 602 is in a 2D working state, the controller controls the light sources 602d to turn on through the control line to make up for the light blocking effect caused by the grating, when the display grating 602 is in a 3D working state, the controller controls the light sources 602d to turn off through the control line. When the 3D display device is in the 2D working state, since the display grating 602 is between the backlight panel 601 and the liquid crystal display panel 603, part of the light beams emitted by the backlight panel 601 is reflected by the reflective structures of the display grating 602. Thus, the light sources 602d are set on the first side surface 602c of the display grating 602 and turned on through the control line to make up for the light beams reflected by the reflective structure 602a when the display grating 602 is in the 2D working state.

In one embodiment, the first outer surface includes a first transparent area, and the first transparent area is an area other than the areas occupied by the reflective structures 602a, which can make reference to FIG. 3 for details. The details are given above and will not be repeated here.

The first inner surface includes a second transparent area, and the second transparent area is an area other than the areas of the first inner surface which are occupied by the scattering structures 602b, which can make reference to FIG. 4 for details. the details are given above and will not be repeated here.

It should be noted that the scattering structures 602b correspond, on the display grating 602, to the reflective structures 602a, that is, how many reflective structures 602a are arranged on the first outer surface, there will be the same number of scattering structures 602b on the first inner surface correspondingly. An occupied area of each scattering structure 602b is smaller than or equal to an occupied area of each reflective structure 602a, accordingly the second transparent area is greater than or equal to the first transparent area. A center line of each scattering structure 602b coincides with a center line of the corresponding reflective structure 602a, and the reflective structures 602a are extended away from the first outer surface for a preset distance.

It should also be noted that the scattering structures 602b are sequentially arranged recesses which are formed by etching the first outer surface, and the recesses have a depth equal to the preset distance. Bottoms of the recesses are provided with a plurality of light-exiting points. The light-exiting points are configured to scatter the light beams from the light sources 602d to make up for the light beams reflected by the reflective structures 602a.

It can be understood that the first outer surface is a surface of the display grating 602 close to the backlight panel 601, and the first inner surface is an inner surface inside of the display grating 602 with a preset distance from the first outer surface.

A distance between the reflective structures 602a on the display grating 602 and the liquid crystal display panel 603 can be calculated according to the following formula:

$$M = L * P / Q ,$$

where L is a distance between a user and the liquid crystal display panel 603 (namely the distance for the user to watch the liquid crystal display panel 603, such as 60 cm), P is a pixel pitch of the liquid crystal display panel 603, and Q is an interpupillary distance of the user.

It should be noted that the 3D display device also includes a shielding cover 604, the backlight panel 601 is installed on a bottom of the shielding cover 604, the display grating 602 is installed above the backlight panel 601, the liquid crystal display panel 603 is installed above the display grating 602, and the light sources 602d are connected to the first side surface 602c of the display grating 602 through optical adhesive. When the display grating is in the 2D working state, the light sources 602d are controlled to be turned on through the control line, and the light beams are totally reflected between two inner surfaces of the display grating and reflected at the shielding cover. Scattering occurs when the light beams reaches the light-exiting points, and a part of the light beams is directed to the liquid crystal display panel 603, so as to make up for the light beams blocked by the slit grating and make all pixels visible to the left and right eyes.

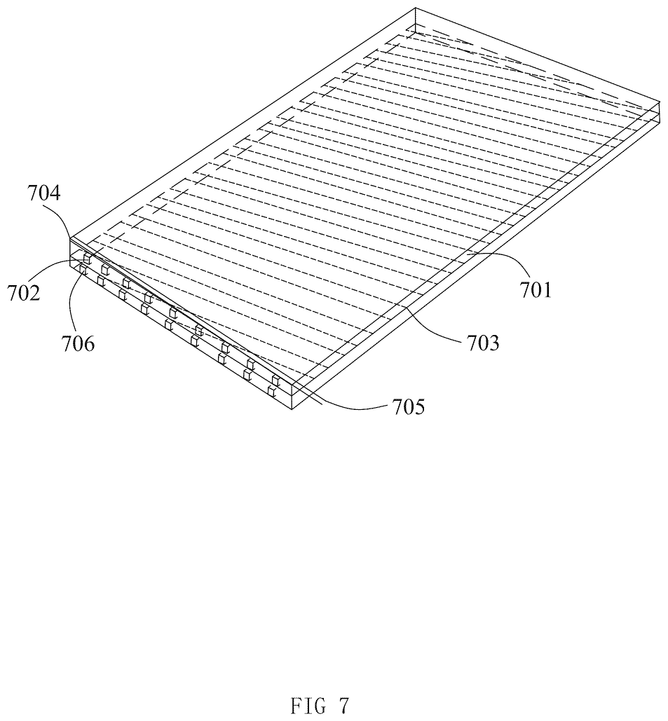

Referring to FIG. 7, FIG. 7 is a schematic diagram of a three-dimensional structure of a 3D display device according to an embodiment of the present application, which includes:
a display grating 701, a grating light source 702, a backlight panel 703, a shielding cover 704, a control line 705 and a backlight source 706;

The backlight panel 703 is installed on a bottom of the shielding cover 704, the display grating 701 is installed above the backlight panel 703, and a liquid crystal display panel (not shown in the figure) is installed above the display grating 701. The grating light source 702 is connected to a first side surface of the display grating 701 through optical adhesive, and the control line 705 is connected to the grating light source 702 for controlling the grating light source 702 to turn off or turn on, that is, when the display grating 701 is in the 2D working state, the grating light source 702 is controlled to be turned on through the control line 705, and when the display grating 701 is in the 3D working state, the grating light source 702 is controlled to turn off through the control line 705. Since the display grating 701 is located between the backlight panel 703 and the liquid crystal display panel, part of the light beams from the backlight panel 703 is reflected by the reflective structures (not shown in the figure) of the display grating 701. Therefore, the grating light source 702 is arranged on the first side surface of the display grating 701 and turned on through the control line to make up for the light beams reflected by the reflective structures when the display grating 701 is in the 2D working state.

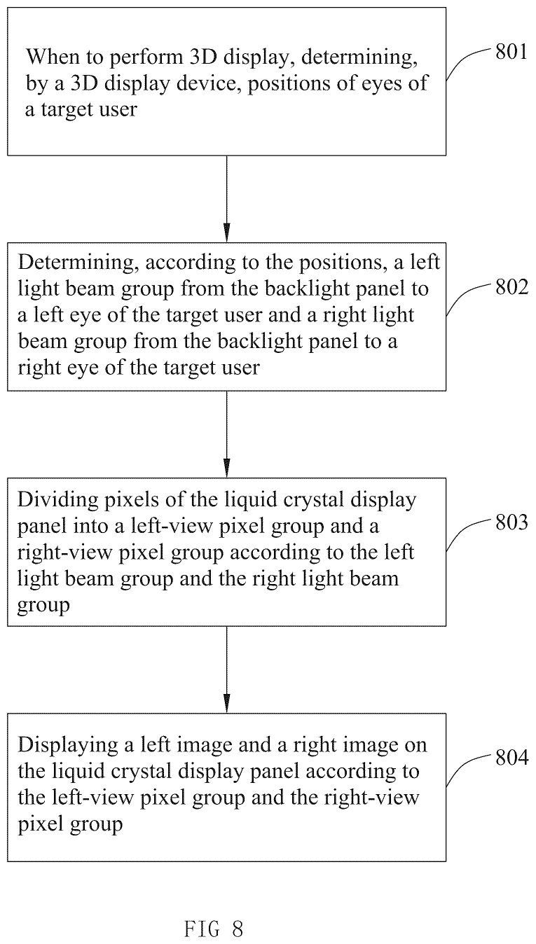

Referring to FIG. 8, FIG. 8 is a schematic flowchart of a 3D display method according to an embodiment of the present application. The 3D display method includes:
801, when to perform 3D display, determining, by a 3D display device, positions of eyes of a target user.

In this embodiment, when to perform 3D display, the 3D display device can determine positions of a target user's eyes. The target user is the one who watches images displayed by the 3D display device at a preset distance. The ways of determining the positions of the target user's eyes are not specifically designated here, for example, the positions of the target user's eyes can be obtained by an eye tracker, and of course, other ways can also be used for the determining of the positions of the target user's eyes.

It should be noted that the 3D display device includes a display grating arranged between a backlight panel and a liquid crystal display panel of the 3D display device. A first outer surface of the display grating is provided with a plurality of sequentially arranged reflective structures, and a first inner surface of the display grating is provided with a plurality of sequentially arranged scattering structures. The scattering structures includes a plurality of light-exiting points, and a first side surface of the display grating is provided with a plurality of sequentially arranged light sources. A controller is connected to the light sources through a control line and configured to control the light sources to be turned off or on. When the display grating is in the 2D working state, the controller controls the light sources to turn on through the control line, and when the display grating is in the 3D working state, the controller controls the light sources to turn off through the control line.
802, determining, according to the positions, a left light beam group from the backlight panel to a left eye of the target user and a right light beam group from the backlight panel to a right eye of the target user.

In this embodiment, through the spectroscopic characteristics of the display grating provided on the 3D display device, the light beams from the backlight panel of the 3D display device are calculated to obtain the left light beam group which will reach the left eye of the target user and the right light beam group which will reach the right eye of the target user according to the positions. The light beams in the left light beam group and the light beams in the right light beam group correspond to the pixels of the liquid crystal display panel. That is, each of the left light beam group and the right light beam group includes a number of light beams. The number of the light beams corresponds to the light transparent area of the display grating of the 3D display device, and the light beams correspond one-to-one to the pixels of the liquid crystal display panel which are viewed by the human eyes through the light beams.

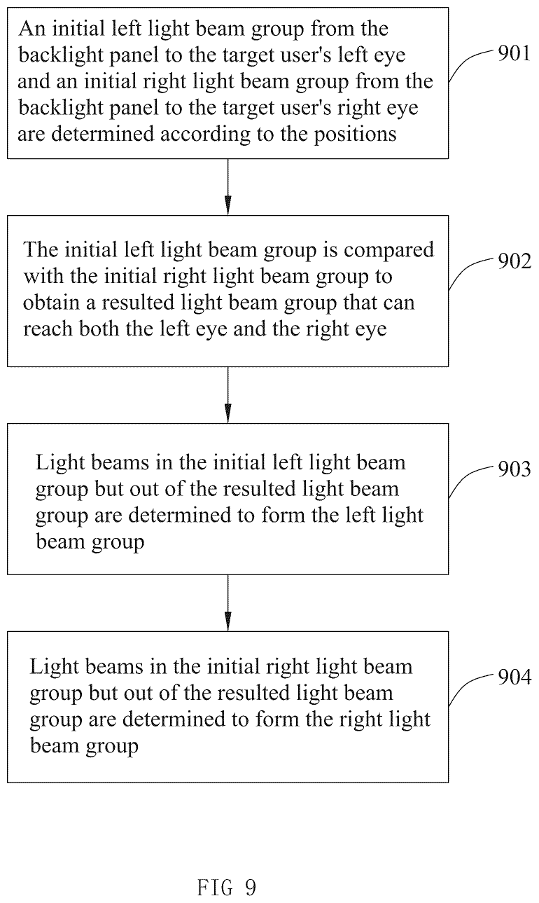

It should be noted that, obviously there will be some of the light beams from the backlight panel of the 3D display device that can reach both the left eye and the right eye, thus before the left light beam group to the target user's left eye and the right light beam group to the target user's right eye are determined, an initial left light beam group from the backlight panel to the target user's left eye and an initial right light beam group from the backlight panel to the target user's right eye can be determined firstly according to the positions (901 of FIG. 9). Then the initial left light beam group is compared with the initial right light beam group to obtain a resulted light beam group that can reach both the left eye and the right eye (902 of FIG. 9), and light beams in the initial left light beam group but out of the resulted light beam group are determined to form the left light beam group (903 of FIG. 9), and light beams in the initial right light beam group but out of the resulted light beam group are determined to form the right light beam group (904 of FIG. 9).
803, dividing pixels of the liquid crystal display panel into a left-view pixel group and a right-view pixel group according to the left light beam group and the right light beam group.

In this embodiment, after the left light beam group to the left eye and the right light beam group to the right eye are determined, since the light beams in each of the left light beam group and the right light beam group correspond one-to-one to the pixels of the liquid crystal display panel which are viewed by the human eyes through the light beams, the pixels of the liquid crystal display panel can be divided into a left-view pixel group and a right-view pixel group according to the left light beam group and the right light beam group. That is, pixels of the liquid crystal display panel that correspond to the left light beam group are determined to form the left-view pixel group, and pixels of the liquid crystal display panel that correspond to the right light beam group are determined to form the right-view pixel group.
804, displaying a left image and a right image on the liquid crystal display panel according to the left-view pixel group and the right-view pixel group.

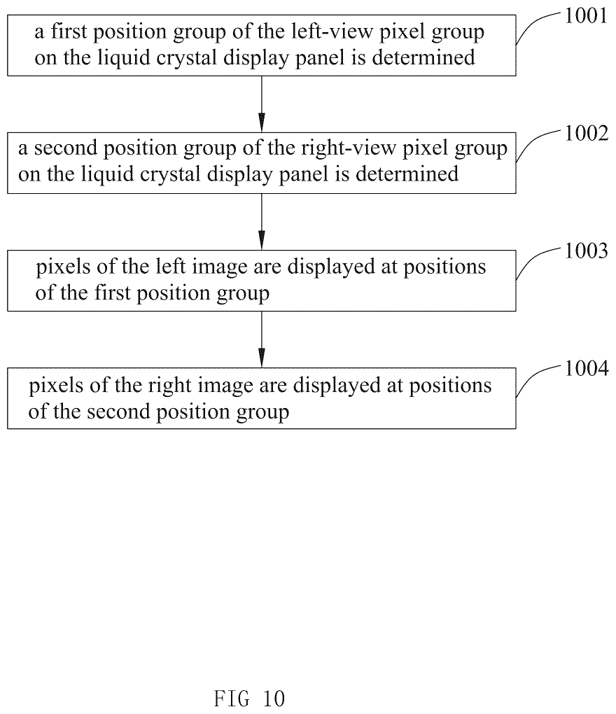

In this embodiment, after the pixels of the liquid crystal display panel are divided into the left-view pixel group and the right-view pixel group, the 3D display device can displays a left image and a right image on the liquid crystal display panel based on the left-view pixel group and the right-view pixel group. The left image and the right image correspond to an image to be displayed in 3D by the 3D display device. In an embodiment, a first position group of the left-view pixel group on the liquid crystal display panel may be determined (1001 of FIG. 10), and a second position group of the right-view pixel group on the liquid crystal display panel may be determined (1002 of FIG. 10). The pixels of the left image are displayed at positions of the first position group (1003 of FIG. 10), and the pixels of the right image are displayed at positions of the second position group (1004 of FIG. 10). That is, when to display a 3D image in a left-right format on the liquid crystal display panel by the 3D display device, the pixels of the left image are displayed at the positions corresponding to the pixels of the left-view pixel group, and the pixels of the right image are displayed at the positions corresponding to the pixels of the right-view pixel group.

It should be noted that, pixels of the liquid crystal display panel corresponding to the light beams that can reach both the left eye and the right eye are not included in the left-view pixel group and the right-view pixel group, and are displayed in low brightness.

In one embodiment, when the 3D display device performs 2D display, pixels of an image displayed on the liquid crystal display panel are arranged normally, and at the same time, the grating light source on the display grating of the 3D display device is illuminated to make up for the light blocking effect caused by the display grating.

In summary, it can be seen that in the embodiments provided by the present application, the light beams of the backlight panel are divided into a left light beam group and a right light beam group through the reflective structures of the display grating provided on the 3D display device, and the pixels of the display panel are divided into a left-view pixel group and a right-view pixel group according to the left light beam group and the right light beam group. After that, the left image and the right image of the image to be displayed in 3D are displayed on the liquid crystal display panel according to the left-view pixel group and the right-view pixel group, and the 3D display effect is realized. Furthermore, during 2D display, the pixels of the image displayed on the liquid crystal display panel can be normally arranged to achieve the 2D display effect.

Finally, it should be noted that the above embodiments are only used to illustrate the embodiments of the present application, and not to limit the present application. Although the present application has been described in detail with reference to the foregoing embodiments, those of ordinary skill in the art should understand that those embodiments can be modified, or some or all of the technical features can be equivalently replaced, and these modifications or substitutions do not deviate from the essence of the corresponding embodiments.

1. (canceled)

2. (canceled)

3. (canceled)

4. (canceled)

5. (canceled)

6. (canceled)

7. (canceled)

8. (canceled)

9. (canceled)

10. (canceled)

11. A display grating, comprising a grating substrate, wherein the grating substrate comprises:
a first outer surface provided with a plurality of sequentially arranged reflective structures;
a first inner surface provided with a plurality of sequentially arranged scattering structures with a plurality of light-exiting points; and
a first side surface provided with a plurality of sequentially arranged light sources.

12. The display grating according to claim 11, further comprising a control line connected to the light sources, wherein the light sources are controlled to turn on through the control line when the display grating is in a 2D working state, and the light sources are controlled to turn off through the control line when the display grating is in a 3D working state.

13. The display grating according to claim 12, wherein,
the first outer surface comprises a first transparent area which is an area of the first outer surface other than areas occupied by the reflective structures;
the scattering structures correspond to the reflective structures one-to-one, an occupied area of each scattering structure is smaller than or equal to an occupied area of a corresponding reflective structure, each scattering structure is aligned with the corresponding reflective structure, and the reflective structures are extended from the first outer surface for a preset distance;
the first inner surface comprises a second transparent area which is an area of the first inner surface other than areas occupied by the scattering structures; and
the second transparent area is greater than or equal to the first transparent area.

14. The display grating according to claim 13, wherein the scattering structures are sequentially arranged recesses which are formed by etching the first outer surface, the recesses have a preset depth, and the plurality of light-exiting points are arranged in the recesses.

15. A 3D display device, comprising:
a backlight panel;
a liquid crystal display panel;
a display grating located between the backlight panel and the liquid crystal display panels and comprising:
a first outer surface provided with a plurality of sequentially arranged reflective structures;
a first inner surface provided with a plurality of sequentially arranged scattering structures with a plurality of light-exiting point; and
a first side surface provided with a plurality of sequentially arranged light sources; and
a controller connected with the light sources through a control line, and configured to control the light sources to turn on through the control line when the display grating is in a 2D working state, and control the light sources to turn off through the control line when the display grating is in a 3D working state.

16. The 3D display device according to claim 15, wherein,
the first outer surface comprises a first transparent area which is an area of the first outer surface other than areas occupied by the reflective structures;
the scattering structures correspond to the reflective structures one-to-one, an occupied area of each scattering structure is smaller than or equal to an occupied area of a corresponding reflective structure, a center line of each scattering structure coincides with a center line of the corresponding reflective structure, and the reflective structures are extended from the first outer surface for a preset distance;
the first inner surface comprises a second transparent area which is an area of the first inner surface other than areas occupied by the scattering structures; and
the second transparent area is greater than or equal to the first transparent area.

17. The 3D display device according to claim 15, wherein,
the first outer surface faces toward the backlight panel, and the first inner surface is an inner surface of the display grating with a preset distance from the first outer surface;
a distance between the reflective structures and the liquid crystal display panel is calculated according to a formula:
$$M = L * P / Q ,$$
wherein M is the distance, L is a distance between a user and the liquid crystal display panel, P is a pixel pitch of the liquid crystal display panel, and Q is an interpupillary distance of the user.

18. The 3D display device according to claim 16, wherein,
the first outer surface faces toward the backlight panel, and the first inner surface is an inner surface of the display grating with a preset distance from the first outer surface;
a distance between the reflective structures and the liquid crystal display panel is calculated according to a formula:
$$M = L * P / Q ,$$
wherein M is the distance between the reflective structures and the liquid crystal display panel, L is a distance between a user and the liquid crystal display panel, P is a pixel pitch of the liquid crystal display panel, and Q is an interpupillary distance of the user.

19. A 3D display method applied to the 3D display device according to claim 15, comprising:
when to perform 3D display, determining, by the 3D display device, positions of eyes of a target user who is ready to watch a 3D image displayed by the 3D display device at a preset distance;
determining, according to the positions, a left light beam group from the backlight panel to a left eye of the target user and a right light beam group from the backlight panel to a right eye of the target user, the backlight panel corresponding to the 3D display, and light beams of the left light beam group and the right light beam group corresponding to pixels of the liquid crystal display panel;
dividing the pixels of the liquid crystal display panel into a left-view pixel group and a right-view pixel group according to the left light beam group and the right light beam group;
displaying a left image and a right image on the liquid crystal display panel based on the left-view pixel group and the right-view pixel group correspondingly, wherein the left image and the right image correspond to the 3D image.

20. The method according to claim 19, wherein the displaying the left image and the right image on the liquid crystal display panel based on the left-view pixel group and the right-view pixel group correspondingly comprises:
determining a first position group of the left-view pixel group on the liquid crystal display panel and a second position group of the right-view pixel group on the liquid crystal display panel;
displaying pixels of the left image at positions of the first position group; and
displaying pixels of the right image at positions of the second position group.

21. The method according to claim 19, wherein, the determining, according to the positions, the left light beam group from the backlight panel to the left eye of the target user and the right light beam group from the backlight panel to the right eye of the target user comprises:
determining an initial left light beam group from the backlight panel to the left eye of the target user and an initial right light beam group from the backlight panel to the right eye of the target user according to the positions;
comparing the initial left light beam group with the initial right light beam group to obtain a resulted light beam group;
determining light beams in the initial left light beam group but out of the resulted light beam group to form the left light beam group;
determining light beams in the initial right light beam group but out of the resulted light beam group to form the right light beam group.

22. The method according to claim 20, wherein, the determining, according to the positions, the left light beam group from the backlight panel to the left eye of the target user and the right light beam group from the backlight panel to the right eye of the target user comprises:
determining an initial left light beam group from the backlight panel to the left eye of the target user and an initial right light beam group from the backlight panel to the right eye of the target user according to the positions;
comparing the initial left light beam group with the initial right light beam group to obtain a resulted light beam group;
determining light beams in the initial left light beam group but out of the resulted light beam group to form the left light beam group;
determining light beams in the initial right light beam group but out of the resulted light beam group to form the right light beam group.
